(19) United States
(12) Patent Application Publication
(10) Pub. No.: US 2013/0295965 A1
(43) Pub. Date: Nov. 7, 2013

(54) METHOD OF VISITOR VOLUME COMPUTING VIA LOCATION UPDATING PROCEDURE

(71) Applicant: Zishuo Li, Fremont, CA (US)

(72) Inventor: Zishuo Li, Fremont, CA (US)

(21) Appl. No.: 13/892,243

(22) Filed: May 11, 2013

(51) Int. Cl. H04W 4/02

(52) U.S. Cl. CPC H04W 4/02
USPC 455/456.3

(57) ABSTRACT

A method of computing the number of visitors via a location updating procedure includes the steps of generating a DTAP by a mobile station, sending the DTAP to an operator mobile network through a base station from the mobile station, and then sending the DTAP to a location updating procedure so as to identify the user's position. The method takes advantages of the existing mobile roaming service cooperated with the location updating procedure to transmit the DTAP from the mobile station to the location updating procedure. Therefore, one can use a searching interne to obtain the number of visitors in a specific location.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a method of computing the number of visitors, and more particularly to a location updating procedure cooperating with a mobile roaming service. A mobile station, such as a mobile phone, generates a location updating request passes to an operator mobile network.

2. Description of Related Arts

During visiting to specific locations, such as attractions, cities, amusement parks, etc., visitors spend a lot of time because of waiting for food, finding a parking space, and having a traffic jam. Moreover, visitors are difficulties to find an accommodation due to the overcrowding. Therefore, visitors may wish to use such information to avoid crowded areas so as to minimum the inconvenience about dining and accommodation.

Accordingly, visitors may benefit from knowing where the largest crowds exist and determine whether to go or not.

In order to solve this problem, a visitor volume computing method is needed to assist visitors to determine the visitor volume of the attractions. Nowadays, it is very common to use a mobile phone, so it is able to corporate the location updating procedure with a mobile roaming service, so as to define the number of mobile phone which resides in the specific location as the visitor's number in this specific location.

### SUMMARY OF THE PRESENT INVENTION

It is a main objective of the present invention to provide a method of computing the number of visitors via a location updating procedure, wherein one can obtain the location of any particular mobile phone user through a mobile roaming service.

It is another objective of the present invention is to provide a method of computing the number of visitors via a location updating procedure, so that the mobile phone user is easily to obtain the number of visitors in a specific location.

It is another objective of the present invention is to provide a method of computing the number of visitors via a location updating procedure, wherein one can easily obtain the number of visitors in a specific location so as to determine whether to go or not.

In order to accomplish the present invention to provide a method of computing the number of visitors via a location updating procedure, which comprises the steps of:

generating a DTAP by a mobile station;

sending the DTAP to an operator mobile network through a base station from the mobile station;

collecting the DTAP by an information collection apparatus from the operator mobile network;

receiving the DTAP by the information processing apparatus through the database interne from the information collection apparatus, wherein the DTAP can be filtered a location updating request and user's position information out the DTAP; and

sending the user's position information from the information processing apparatus to a visitor information server to store the user's position information;

periodically sending the DTAP to the information processing apparatus, wherein the mobile station is counted in the service area of the base station based on the updating period of the location updating request that exceeds a period for a periodic location updating;

classifying the location updating request by the service area and time period;

providing visitor volume retrieval service according to the service area and time period.

These and other objectives, features, and advantages of the present invention will become apparent from the following detailed description, the accompanying drawings, and the appended claims.

### BRIEF DESCRIPTION OF THE DRAWINGS

FIG. 1 is a block diagram illustrating the procedure of a location updating procedure cooperated with a mobile roaming service.

### DETAILED DESCRIPTION OF THE PREFERRED EMBODIMENT

The present invention provides an effective approach to compute the number of visitors in an area, such as attractions and, cities via cellular roaming system. The main concept of the present invention is to apply a cellular roaming system to a location updating procedure.

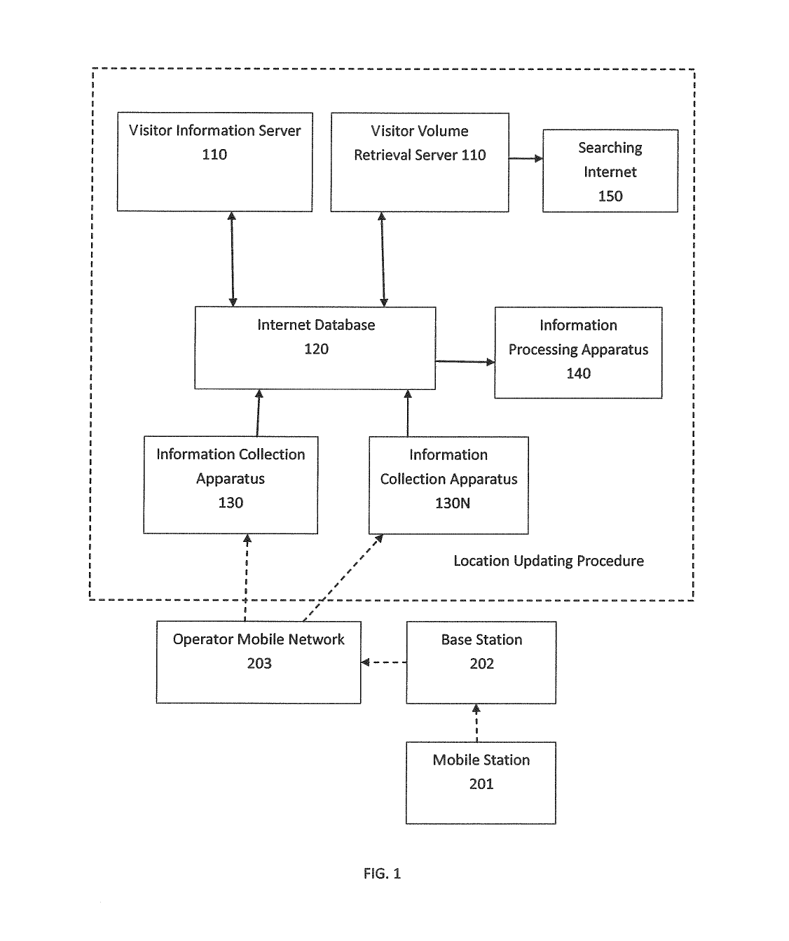

Referring to FIG. 1, a universal mobile station 201 wirelessly connected with a base station 202. This universal mobile station can be a cellular phone which is able to generate a Direct Transfer Application Sub-Part (DTAP). The DTAP is used to transfer call control and mobility management messages to and from the mobile station 201. In addition, the base station is a Base Station Controller (BSC) in 2G communication networks and a Radio Network Controller (RNC) in 3G communication networks. An operator mobile network 203 is also connected to the base station 202. The base station 202 is responsible for transmit the DTAP between the mobile station 201 and the operator mobile network 203. Moreover, the operator mobile network 203 is able to provide the DTAP generated by the mobile station 201 to identify the location of the mobile station 201 through a location updating procedure.

To process the DTAP via location updating procedure of the present invention, a visitor volume retrieval server 100, a visitor information server 110, an information processing apparatus 140, and a plurality number of information collection apparatus 130,13N are connected with an internet database 120 via the Socket of TCP/IP in order to establish a logical internet communication. TCP/IP provides end-to-end connectivity specifying how data should be formatted, addressed, transmitted, routed and received at the destination.

The method of computing visitor volume via location updating procedure according to the present invention comprise the steps as followings:

(1) sending the DTAP to the operator mobile network 203 through the base station 202 from the mobile station 201.

(2) collecting the DTAP by the information collection apparatus 130,13N from the operator mobile network 203, wherein the DTAP gives the service area in which the mobile station 201 currently resides.

(3) receiving the DTAP by the information processing apparatus 140 through the database internet 120 from the information collection apparatus 130,13N, wherein the information processing apparatus 140 is arranged to filter a location updating request out the DTAP. By this way, the information processing apparatus 140 is also able to filter a user's position information out the location updating request.

(4) sending the user's position information by the information processing apparatus 140 to the visitor information server 110 to store the user's position information.

(5) periodically sending the DTAP to the information processing apparatus 140. Depending on the updating period of the location updating request, the mobile station 201 is counted in the service area of the base station 202 based on the updating period of the location updating request exceed a period for a periodic location updating.

(6) classifying the location updating request by the service area and time period, and wherein the classified location updating request is stored in the visitor information server 110.

(7) providing the visitor volume retrieval service according to the service area and time period.

It is worth to mention that the location updating request mentioned on the above step (2) is sent by the mobile station 201 to the operator mobile network 203 either to request update of its location file, such as normal updating and period updating, and to request IMSI attach. The user's position information mentioned in the above step (3) are mobile identity data, which are provide either the international mobile subscriber identity, IMSI, the temporary mobile subscriber identity, TMSI, the international mobile equipment identity, IMEI, and the international mobile equipment identity together with the software version number, IEMISV.

Accordingly, the information collections apparatus 130,13N are connected with the information processing apparatus 140 through the internet database 120, wherein the data mirror image technology is applied by the information collection apparatus to collect the IP packets passing between the operator mobile network 203 and the base station 202. The visitor's information server 110 is also connected with the information processing apparatus 140 through the internet database 120 to store the user's position information of the currently time period. Moreover, the visitor volume retrieval server 100 is connected with the visitor's information server 110 via the internet database 120, and also connected with a searching internet 150 to provide the visitor volume retrieval service within the service area and time period.

In addition, the visitor volume retrieval server 100 is able to forecast the visitors' volume in the future within the service area.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of computing the number of visitors via a location updating procedure, comprising the steps of:
(A) generating a DTAP by a mobile station;
(B) sending said DTAP to an operator mobile network through a base station from said mobile station;
(C) collecting said DTAP by an information collection apparatus from said operator mobile network;
(D) receiving said DTAP by said information processing apparatus through said database internet from said information collection apparatus, wherein said DTAP can be filtered a location updating request and user's position information out said DTAP;
(E) sending said user's position information from said information processing apparatus to a visitor information server to store said user's position information;
(F) periodically sending said DTAP to said information processing apparatus, wherein said mobile station is counted in the service area of said base station based on the updating period of said location updating request which exceeds a period for a periodic location updating; and
(G) classifying said location updating request by the service area and time period; and
(H) providing visitor volume retrieval service according to the service area and time period.

2. A method of computing the number of visitors via a location updating procedure, as recited in claim 1, wherein in step (A), said DTAP is the direct transfer application sub-part, which is used to transfer call control and mobility management messages to and from said mobile station.

3. A method of computing the number of visitors via a location updating procedure, as recited in claim 1, wherein in step (B), said base station is a Base Station Controller (BSC) in 2G communication networks and a Radio Network Controller (RNC) in 3G communication networks.

4. A method of computing the number of visitors via a location updating procedure, as recited in claim 1, wherein in step (D), said location updating request is sent by said mobile station to said operator mobile network either to request update of its location file.

5. A method of computing the number of visitors via a location updating procedure, as recited in claim 1, wherein in step (D), said user's position information is a mobile identify, which is to provide either the international mobile subscriber identity, IMSI, the temporary mobile subscriber identity, TMSI, the international mobile equipment identity, IMEI, and the international mobile equipment identity together with the software version number, IEMISV.

6. A method of computing the number of visitors via a location updating procedure, comprising:
an information collection apparatus connected with an information processing apparatus through an internet database, wherein the data mirror image technology is applied by said information collection apparatus to collect the IP packets passing between a operator mobile network and a base station;
a visitor's information server connected with said information processing apparatus through the internet database to store the user's position information of the currently time period;
a visitor volume retrieval server connected with said visitor's information server via the internet database 120, and also connected with a searching internet to provide the visitor volume retrieval service within the service area and time period.

7. A method of computing the number of visitors via a location updating procedure, as recited in claim 6, wherein said visitor volume retrieval server is able to forecast the visitors' volume in the future within the service area.
